(19) United States
(12) Patent Application Publication
(10) Pub. No.: US 2026/0180071 A1
(43) Pub. Date: Jun. 25, 2026

(54) ELECTRIC STORAGE APPARATUS

(71) Applicant: TOYOTA JIDOSHA KABUSHIKI KAISHA, Toyota-shi (JP)

(72) Inventors: Takenori MIKAMI, Miyoshi-shi (JP); Kenji BABA, Seto-shi (JP); Keita AOYAMA, Kasugai-shi (JP)

(73) Assignee: TOYOTA JIDOSHA KABUSHIKI KAISHA, Toyota-shi (JP)

(21) Appl. No.: 19/396,477

(22) Filed: Nov. 21, 2025

(30) Foreign Application Priority Data
Dec. 19, 2024 (JP) 2024-223731

(51) Int. Cl. H01M 10/6563; H01M 10/613

(52) U.S. Cl. CPC H01M 10/6563; H01M 10/613

(57) ABSTRACT

An electric storage apparatus capable of suppressing an adverse effect of water entering the inside of the electric storage apparatus on an electric equipment is provided. In an electric storage apparatus, a housing includes: a partition member including a support surface that supports a temperature control apparatus and a wall surface that rises from the support surface; and a first communication port and a second communication port each disposed in a part of the housing that faces the wall surface of the partition member. The support surface of the partition member is inclined so as to become lower toward a side of the second communication port of the housing.

### CROSS REFERENCE TO RELATED APPLICATIONS

This application is based upon and claims the benefit of priority from Japanese patent application No. 2024-223731, filed on Dec. 19, 2024, the disclosure of which is incorporated herein in its entirety by reference.

### BACKGROUND

The present disclosure relates to an electric storage apparatus.

An electric storage apparatus is installed, for example, in a house or a factory. For example, as disclosed in Patent Literature 1, an electric storage apparatus is configured so that an electric equipment such as a storage battery and a control apparatus is housed in a housing.

[Patent Literature 1] Japanese Unexamined Patent Application Publication No. 2024-102546

### SUMMARY

In a general electric storage apparatus, rainwater or the like may enter the inside of the electric storage apparatus, and it is desirable that the electric equipment be configured so as not to be adversely affected by the water.

The present disclosure provides an electric storage apparatus capable of suppressing an adverse effect of water entering the inside of the electric storage apparatus on an electric equipment.

An electric storage apparatus according to an aspect of the present disclosure is an electric storage apparatus including: an electric equipment including a storage battery; and a housing configured to house the electric equipment, in which
the housing includes:
   a partition member including a support surface that supports a temperature control apparatus configured to cool a refrigerant for cooling the electric equipment, and a wall surface that rises upward from the support surface, the partition member being configured to form a temperature control space inside the housing;
   a first communication port configured to communicate with the temperature control space and disposed in a part of the housing that faces the wall surface of the partition member; and
   a second communication port configured to communicate with the temperature control space and disposed below the first communication port in a part of the housing that faces the wall surface of the partition member,
the support surface of the partition member is inclined so as to become lower toward a side of the second communication port of the housing, and
air and water that have flown into the housing through the first communication port come into contact with the wall surface of the partition member via the temperature control apparatus, and the water that has flown on the wall surface of the partition member and dropped is guided to the second communication port by the air that is returned by the wall surface of the partition member.

In the above-described electric storage apparatus, the first communication port and the second communication port are preferably disposed in a rear part of the housing, and
the housing preferably communicates with the temperature control space and includes a third communication port disposed in at least one of a left part of the housing and a right part of the housing.

In the above-described electric storage apparatus, the support surface of the partition member and the second communication port of the housing are preferably continuously formed.

In the above-described electric storage apparatus, an inclination angle of the support surface of the partition member is preferably greater than or equal to 0.5° but smaller than or equal to 3°.

According to the present disclosure, it is possible to provide an electric storage apparatus capable of suppressing an adverse effect of water entering the inside of the electric storage apparatus on an electric equipment.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of an electric storage apparatus according to an embodiment when viewed from an X-axis positive side;

FIG. 2 is a perspective view of the electric storage apparatus according to the embodiment when viewed from an X-axis negative side;

FIG. 3 is a diagram of an internal structure of the electric storage apparatus according to the embodiment when viewed from a Y-axis negative side;

FIG. 4 is an enlarged X-Z cross-sectional view showing the vicinity of a second communication port of a housing in the electric storage apparatus according to the embodiment; and

FIG. 5 is a diagram for explaining an air flow in a first space in the electric storage apparatus according to the embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate.

First, a configuration of an electric storage apparatus according to this embodiment will be described. The following description will be given using a three-dimensional (XYZ) coordinate system in order to clarify the description. Note that, for example, an X-axis positive side is the front side of the electric storage apparatus, an X-axis negative side is the rear side of the electric storage apparatus, a Y-axis positive side is the left side of the electric storage apparatus, a Y-axis negative side is the right side of the electric storage apparatus, a Z-axis positive side is the upper side of the electric storage apparatus, and a Z-axis negative side is the lower side of the electric storage apparatus.

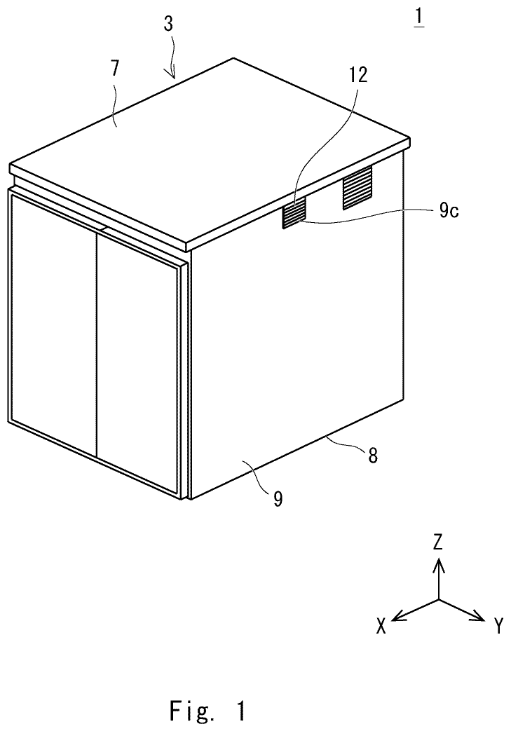

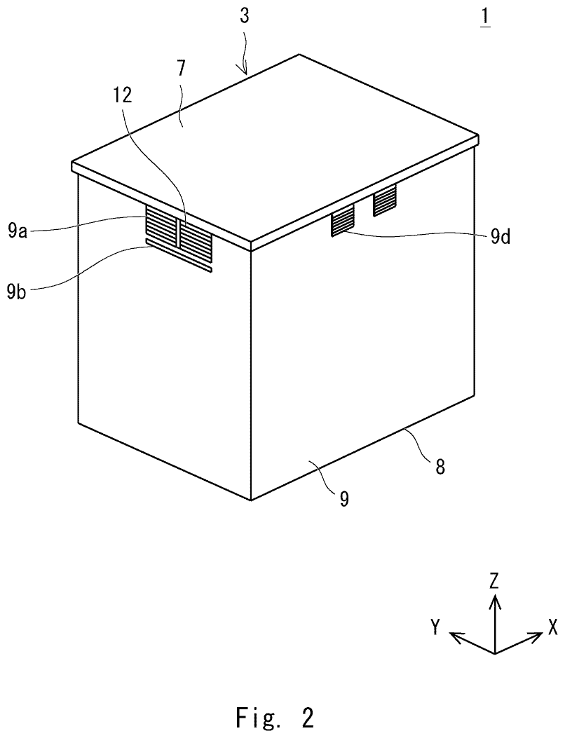

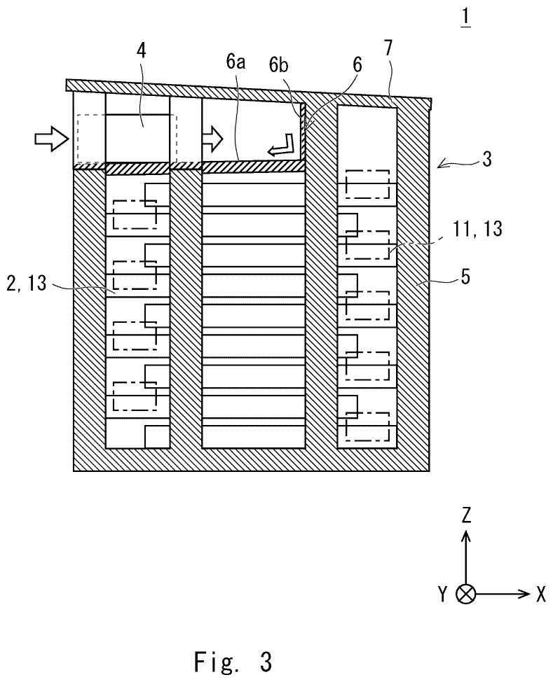

FIG. 1 is a perspective view of the electric storage apparatus according to this embodiment when viewed from the X-axis positive side. FIG. 2 is a perspective view of the electric storage apparatus according to this embodiment when viewed from the X-axis negative side. FIG. 3 is a diagram of an internal structure of the electric storage apparatus according to this embodiment when viewed from the Y-axis negative side.

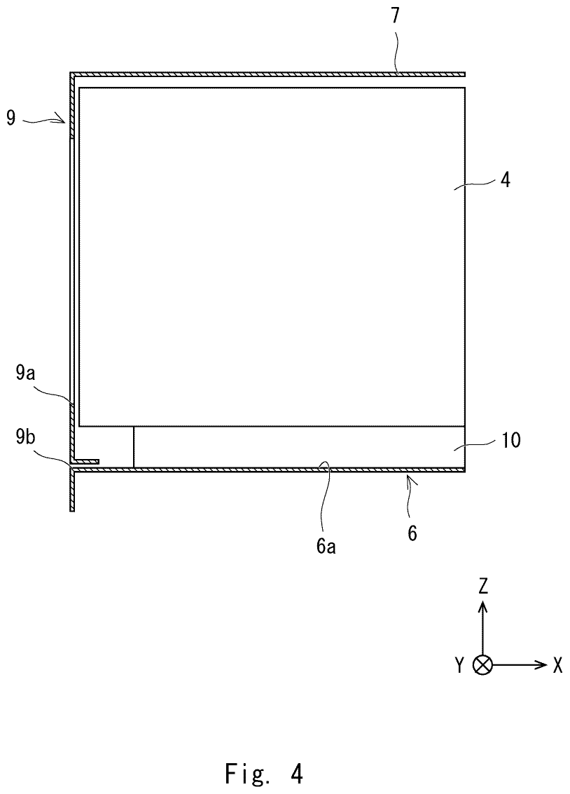

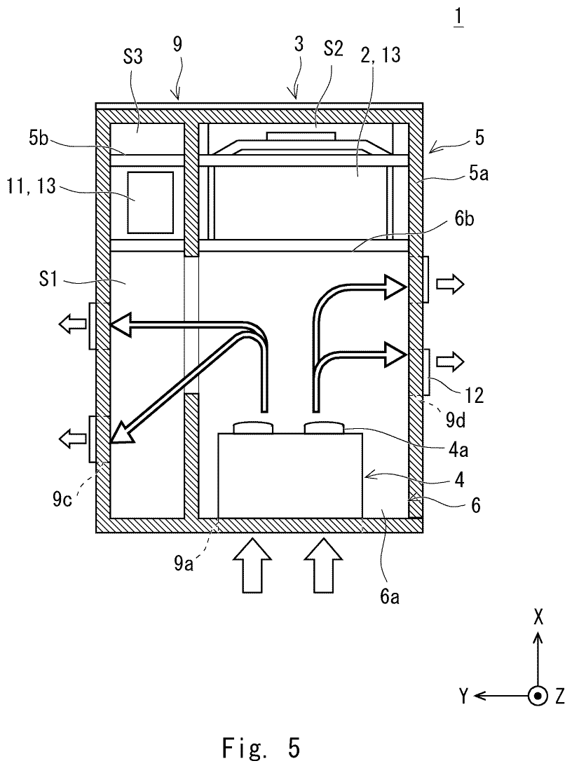

FIG. 4 is an enlarged X-Z cross-sectional view showing the vicinity of a second communication port of a housing in the electric storage apparatus according to this embodiment. FIG. 5 is a diagram for explaining an air flow in a first space in the electric storage apparatus according to this embodiment.

An electric storage apparatus 1 includes, for example, battery packs 2, a housing 3, and a temperature control apparatus 4 as shown in FIGS. 1 to 5. The battery pack 2 is a storage battery and has, for example, a configuration substantially similar to that of a general vehicle-mounted battery pack.

The battery pack 2 is formed by housing a battery module inside the housing, and may be, for example, a lithium-ion battery, a nickel-hydrogen battery, a nickel-cadmium battery, or an all-solid-state battery. As shown in FIG. 3, for example, the battery pack 2 has a substantially rectangular shape when viewed in the Z-axis direction and a flat plate shape substantially parallel to the XY plane. The battery packs 2 are stacked in the Z-axis direction.

As shown in FIGS. 1 to 5, for example, the housing 3 has a box shape and includes a frame 5, a partition member 6, a roof part 7, a floor part 8, and a side wall part 9. The frame 5 is formed of, for example, a combination of hollow square members, and includes column units 5a and a beam member 5b.

As shown in FIG. 5, for example, the column units 5a are disposed substantially parallel to the XZ plane and at intervals in the Y-axis direction. In this embodiment, for example, three of the column units 5a are disposed at intervals in the Y-axis direction. The beam member 5b extends in the Y-axis direction and connects the adjacent column units 5a in the Y-axis direction.

As shown in FIG. 3, for example, the partition member 6 is a plate member bent in a substantially L-shape when viewed in the Y-axis direction, and includes a support surface 6a and a wall surface 6b. The support surface 6a, for example, supports the temperature control apparatus 4 through a jig 10 as shown in FIG. 4.

As shown in FIGS. 3 and 4, the support surface 6a is an inclined surface gradually inclined in the Z-axis negative side direction toward the X-axis negative side. The inclination angle of the support surface 6 a is preferably, for example, greater than or equal to 0.5° but smaller than or equal to 3°. The wall surface 6 b is disposed substantially parallel to the YZ plane, and rises from the end part of the support surface 6a on the X-axis positive side toward the Z-axis positive side.

As shown in FIG. 3, the partition member 6 is disposed so as to extend from the column unit 5a of the frame 5 on the Y-axis positive side to the central column unit 5a of the frame 5, and so as to further extend from the column unit 5a of the frame 5 on the Y-axis negative side to the central column unit 5a of the frame 5.

Further, as shown in FIG. 3, the partition member 6 is disposed in the part of the frame 5 on the Z-axis positive side and on the X-axis negative side. That is, when viewed in the Y-axis direction, the partition member 6 is disposed so as to cover a corner part of the frame 5 on the Z-axis positive side and on the X-axis negative side.

The partition member 6 is fixed to the frame 5. Thus, as shown in FIGS. 3 and 5, the inside of the housing 3 includes a first space S1, a second space S2, and a third space S3. The first space S1 is a space surrounded by the partition member 6 inside the housing 3. The temperature control apparatus 4 is disposed in the first space S1.

For example, as shown in FIGS. 3 and 5, the second space S2 is a space between the column unit 5a on the Y-axis negative side and the central column unit 5a inside the housing 3 excluding the first space S1. The battery packs 2 are housed in the second space S2 in a state in which they are stacked on each other. The battery packs 2 are fixed to the frame 5.

As shown in FIG. 5, for example, the third space S3 is a space between the column unit 5a on the Y-axis positive side and the central column unit 5a inside the housing 3 excluding the first space S1. A control apparatus 11 such as a power control unit that controls each of the battery packs 2 is housed in the third space S3. The control apparatus 11 is fixed to the frame 5.

As shown in FIGS. 1 and 2, a roof part 7 covers an open part of the frame 5 on the Z-axis positive side. An end part of the wall surface 6b of the partition member 6 on the Z-axis positive side is preferably in contact with the roof part 7. The floor part 8 covers an open part of the frame 5 on the Z-axis negative side. The side wall part 9 covers an open part of the frame 5 on the X-axis positive side, an open part of the frame 5 on the X-axis negative side, an open part of the frame 5 on the Y-axis positive side, and an open part of the frame 5 on the Y-axis negative side.

As shown in FIG. 1, for example, the side wall part 9 on the X-axis positive side may be formed by an openable/closable door. As shown in FIG. 2, a first communication port 9a and a second communication port 9b for communicating the part of the first space S1 on the X-axis negative side with the outside are formed in the side wall part 9 on the X-axis negative side.

The first communication port 9a, for example, is disposed in a part between the column unit 5a on the Y-axis negative side and the central column unit 5a in the side wall part 9 on the X-axis negative side, and on the Z-axis positive side with respect to the support surface 6a of the partition member 6.

As shown in FIG. 4, the second communication port 9b is disposed in a part between the column unit 5a on the Y-axis negative side and the central column unit 5a in the side wall part 9 on the X-axis negative side, on the Z-axis positive side with respect to the support surface 6a of the partition member 6, and on the Z-axis negative side with respect to the first communication port 9a.

Therefore, the first communication port 9a and the second communication port 9b are disposed so as to face the wall surface 6b of the partition member 6 in the X-axis direction. At this time, the end part of the second communication port 9b on the Z-axis negative side may be continuously formed with the support surface 6a of the partition member 6.

As shown in FIG. 1, third communication ports 9c for communicating the part of the first space S1 on the Y-axis positive side with the outside are formed in the side wall part 9 on the Y-axis positive side. The third communication ports 9c, for example, are disposed in the part on the X-axis negative side of the side wall part 9 on the Y-axis positive side and on the Z-axis positive side of the side wall part 9 on the Y-axis positive side at intervals in the X-axis direction.

As shown in FIG. 2, fourth communication ports 9d for communicating the part of the first space S1 on the Y-axis negative side with the outside are formed in the side wall part 9 on the Y-axis negative side. The fourth communication ports 9d, for example, are disposed in the part on the X-axis negative side of the side wall part 9 on the Y-axis negative side and on the Z-axis positive side of the side wall part 9 on the Y-axis negative side at intervals in the X-axis direction. A louver 12 is preferably fitted into each of the first communication port 9a, the third communication ports 9c, and the fourth communication ports 9d.

The temperature control apparatus 4 cools a refrigerant circulating in an electric equipment 13 in order to cool the electric equipment 13 including the battery packs 2 and the control apparatus 11. The temperature control apparatus 4 can cool a refrigerant by bringing air (i.e., outside air) taken in by a fan 4a into contact with a refrigerant circuit in which the refrigerant circulates. Therefore, the first space S1 of the housing 3 functions as a temperature control space.

As shown in FIGS. 3 and 4, the temperature control apparatus 4 is fixed to a part of the support surface 6a of the partition member 6 on the X-axis negative side. At this time, as shown in FIG. 5, the temperature control apparatus 4 may be disposed so as to overlap the first communication port 9a of the housing 3 when viewed in the X-axis direction.

Next, the flow of air and water taken in by the fan 4a of the temperature control apparatus 4 in the electric storage apparatus 1 according to this embodiment will be described. Note that, in FIG. 3, the flow of water is indicated by arrows, and in FIG. 5, the flow of air is indicated by arrows.

As shown in FIG. 5, air flows into the first space S1 of the housing 3 through the first communication port 9a of the housing 3 by the fan 4a of the temperature control apparatus 4. At this time, for example, water such as rainwater flows into the first space S1 of the housing 3 together with air.

As shown in FIG. 5, the air and the water flowing into the first space S1 are drawn to the X-axis positive side by the fan 4a, come into contact with the refrigerant circuit in the temperature control apparatus 4 to cool a refrigerant, and then come into contact the wall surface 6b of the partition member 6.

As a result, the air that has come into contact with the wall surface 6b of the partition member 6 is divided into the Y-axis positive side, the Y-axis negative side, and the X-axis negative side, and as shown in FIG. 5, the air guided to the Y-axis positive side is discharged from the third communication ports 9c of the housing 3, and the air guided to the Y-axis negative side is discharged from the fourth communication ports 9d of the housing 3.

At this time, as shown in FIG. 3, the water that has come into contact with the wall surface 6b of the partition member 6 flows on the wall surface 6b and drops on the support surface 6a of the partition member 6. Since the support surface 6a of the partition member 6 is gradually inclined in the Z-axis negative side direction toward the X-axis negative side, the water flows on the support surface 6a, is guided to the second communication port 9b of the housing 3, and is discharged from the second communication port 9b.

Then, since the air that has come into contact with the wall surface 6b of the partition member 6 is returned to the X-axis negative side, the water flowing on the support surface 6a by the air can be satisfactorily guided to the second communication port 9b of the housing 3. Therefore, the water flowing into the first space S1 can be satisfactorily discharged to the outside of the electric storage apparatus 1, and an adverse effect of the water flowing into the electric storage apparatus 1 on the electric equipment 13 can be suppressed.

As described above, the electric storage apparatus 1 according to this embodiment is configured to bring the water flowing into the first space S1 into contact with the wall surface 6b of the partition member 6, drop it on the support surface 6a, and guide it to the second communication port 9b of the housing 3 by the air returned by the wall surface 6b and the inclination of the support surface 6a to discharge it. Therefore, the water flowing into the first space S1 can be satisfactorily discharged to the outside of the electric storage apparatus 1, and an adverse effect on the electric equipment 13 caused by the water flowing into the electric storage apparatus 1 can be suppressed.

In particular, since the electric storage apparatus 1 according to this embodiment is configured so as to guide water to the second communication port 9b of the housing 3 by air returned by the wall surface 6b of the partition member 6 to discharge it, the inclination angle of the support surface 6a of the partition member 6 can be reduced to, for example, greater than or equal to 0.5° but smaller than or equal to 1°. Thus, the volume consumed by the support surface 6a of the partition member 6 can be reduced, and hence it is possible to contribute to the reduction of the size of the electric storage apparatus 1.

In the electric storage apparatus 1 according to this embodiment, when the first communication port 9a and the second communication port 9b of the housing 3 are formed in the side wall part 9 of the housing 3 on the X-axis negative side, air is not discharged from the side wall part 9 of the housing 3 on the X-axis positive side, and, for example, when the X-axis positive side of the electric storage apparatus 1 is set as the front surface thereof, the generation of noise at the front surface of the electric storage apparatus 1 can be suppressed.

In the electric storage apparatus 1 according to this embodiment, when the support surface 6a of the partition member 6 and the second communication port 9b of the housing 3 are continuously formed, the water flowing into the first space S1 can be satisfactorily discharged to the outside of the electric storage apparatus 1.

Although the second communication port 9b is disposed between the column unit 5a on the Y-axis negative side and the central column unit 5a, it may also be disposed between the column unit 5a on the Y-axis positive side and the central column unit 5a.

The arrangement of the third communication port 9c and the fourth communication port 9d according to this embodiment is merely an example, and, for example, one of these communication ports may be omitted. Further, the configuration of the temperature control apparatus 4 is merely an example, and any configuration by which the battery pack 2 and the control apparatus 11 can be cooled may be employed.

Although the electric storage apparatus 1 according to this embodiment has a configuration in which the battery packs 2 are stacked in the Z-axis direction, it is sufficient to include a single or a plurality of storage batteries.

In short, the electric storage apparatus 1 according to this embodiment may be configured so as to guide water flowing into the first space S1 to the second communication port 9b of the housing 3 by air returned by the wall surface 6b of the partition member 6 and the inclination of the support surface 6a of the partition member 6 to discharge it.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising: an electric equipment including a storage battery; and a housing configured to house the electric equipment, wherein
the housing comprises:
a partition member including a support surface that supports a temperature control apparatus configured to cool a refrigerant for cooling the electric equipment, and a wall surface that rises upward from the support surface, the partition member being configured to form a temperature control space inside the housing;
a first communication port configured to communicate with the temperature control space and disposed in a part of the housing that faces the wall surface of the partition member; and
a second communication port configured to communicate with the temperature control space and disposed below the first communication port in a part of the housing that faces the wall surface of the partition member,
the support surface of the partition member is inclined so as to become lower toward a side of the second communication port of the housing, and
air and water that have flown into the housing through the first communication port come into contact with the wall surface of the partition member via the temperature control apparatus, and the water that has flown on the wall surface of the partition member and dropped is guided to the second communication port by the air that is returned by the wall surface of the partition member.

2. The electric storage apparatus according to claim 1, wherein
the first communication port and the second communication port are disposed in a rear part of the housing, and
the housing communicates with the temperature control space and includes a third communication port disposed in at least one of a left part of the housing and a right part of the housing.

3. The electric storage apparatus according to claim 1, wherein the support surface of the partition member and the second communication port of the housing are continuously formed.

4. The electric storage apparatus according to claim 1, wherein an inclination angle of the support surface of the partition member is greater than or equal to 0.5° but smaller than or equal to 3°.
